(19) United States
(12) Patent Application Publication
(10) Pub. No.: US 2013/0068576 A1
(43) Pub. Date: Mar. 21, 2013

(54) WHEEL CYLINDER AND DRAUM BRAKE WITH THE SAME

(71) Applicant: Weon Chan KO, Pyeongtaek-Si (KR)

(72) Inventor: Weon Chan KO, Pyeongtaek-Si (KR)

(21) Appl. No.: 13/620,387

(22) Filed: Sep. 14, 2012

(30) Foreign Application Priority Data
Sep. 16, 2011 (KR) 10-2011-0093397

(51) Int. Cl. B60T 1/06; F16D 65/22

(52) U.S. Cl. 188/327; 188/363

(57) ABSTRACT

Disclosed is a wheel cylinder and a drum brake having the same, in which the number of position as well as other elements accompanied with the piston may be reduced, resulting in reduced manufacturing cost.

### CROSS-REFERENCE TO RELATED APPLICATION

This application claims the benefit of Korean Patent Application No. 2011-0093397, filed on Sep. 16, 2011 in the Korean Intellectual Property Office, the disclosure of which is incorporated herein by reference.

### BACKGROUND

1. Field

Embodiments of the present invention relate to a wheel cylinder having a reduced size and manufacturing cost owing to a simplified configuration, and a drum brake with the same.

2. Description of the Related Art

Generally, a drum brake usable with a vehicle is a device that stops a vehicle by frictional brake force generated when a brake shoe having a lining attached thereto forcibly comes into contact with an inner surface of a cylindrical drum that rotates along with a vehicle wheel.

A conventional drum brake includes a pair of brake shoes placed within a drum that rotates along with a vehicle wheel.

The pair of brake shoes is mounted to a backing plate in an outwardly operable manner, and the backing plate is secured to a knuckle of the vehicle so as to be opposite the drum. A lining for frictional interaction with an inner surface of the drum is attached to an outer surface of each brake shoe.

A wheel cylinder is installed between one end of each of the pair of brake shoes to push each brake shoe against the inner surface of the drum, causing friction therebetween. The other ends of the pair of brake shoes are rotatably supported by an anchor block installed therebetween. Both the wheel cylinder and the anchor block are fixedly mounted to the backing plate.

FIG. 1 shows the configuration of a conventional wheel cylinder.

As shown in FIG. 1, the conventional wheel cylinder includes a pair of pistons 1 and 2 to push each brake shoe in an outward operating direction, and a cylinder 3 in which the pair of pistons 1 and 2 are reciprocally movably received.

The cylinder 3 is fixed to a backing plate. The cylinder 3 internally defines a cylinder chamber 3a, both ends of which are open, and the pair of pistons 1 and 2 is reciprocally movably placed at both sides of the cylinder chamber 3a respectively. A spring 4 is placed in the cylinder chamber 3a between the pistons 1 and 2 to maintain balance of the pistons 1 and 2. The cylinder chamber 3a may receive hydraulic pressure transmitted between the pistons 1 and 2.

To prevent the hydraulic pressure applied into the cylinder chamber 3a from leaking out of the cylinder 3 and to prevent foreign substances at the outside of the cylinder 3 from entering the cylinder chamber 3a, boots 5 and 6 are interposed between both ends of the cylinder 3 and leading ends of the pistons 1 and 2. Also, seals 7 and 8 are interposed between an inner wall of the cylinder chamber 3a and outer surfaces of the pistons 1 and 2, to reduce loss of hydraulic pressure applied to the pistons 1 and 2.

In the wheel cylinder having the above-described configuration, hydraulic pressure, which is transmitted into the cylinder chamber 3a when a driver steps on a brake pedal, forces the pistons 1 and 2 to move outward of the cylinder 3, thereby causing the pistons 1 and 2 to push both the brake shoes in an outward operating direction. The drum brake implements braking of a vehicle via this operation of the wheel cylinder.

However, in the case of the conventional wheel cylinder in which the pair of pistons is provided to actuate the drum brake, a total length of the wheel cylinder is increased due to the pair of pistons, and reduction in size of the wheel cylinder is limited.

Further, the wheel cylinder with the pair of pistons includes an increased number of elements accompanied with the pistons, such as the boots and seals. Thus, the wheel cylinder has a complicated configuration and high manufacturing cost.

### SUMMARY

Therefore, it is an aspect of the present invention to provide a wheel cylinder having a reduced size and manufacturing cost owing to a simplified configuration, and a drum brake with the same.

Additional aspects of the invention will be set forth in part in the description which follows and, in part, will be obvious from the description, or may be learned by practice of the invention.

In accordance with one aspect of the present invention, a wheel cylinder, which is installed in a drum brake to push a pair of brake shoes placed in both sides of the drum outward, includes a piston to push any one of the pair of brake shoes outward, and a cylinder in which the piston is reciprocally movably received, the cylinder being installed to slide in linkage with operation of the piston so as to push the other one of the pair of brake shoes outward.

In accordance with another aspect of the present invention, a drum brake includes a backing plate installed opposite a drum that rotates along with a wheel, a pair of brake shoes installed in both sides of the drum to generate brake force via friction with an inner surface of the drum when pushed outward, and a wheel cylinder located between one end of each of the pair of brake shoes to push the pair of brake shoes outward, wherein the wheel cylinder includes a piston to push one end of any one of the pair of brake shoes outward, and a cylinder in which the piston is reciprocally movably received, the cylinder being installed to slide in linkage with operation of the piston so as to push one end of the other one of the pair of brake shoes outward.

The cylinder may have a coupling portion for coupling with the backing plate, and the backing plate may have a sliding hole such that the coupling portion is slidably fitted into the sliding hole.

The cylinder may include a cylinder body in which the piston is reciprocally movably received, and a contact member secured to one side of the cylinder body so as to come into contact with the brake shoe.

An end of the contact member coming into contact with the brake shoe may be provided with a fitting recess, into which the end of the brake shoe is fitted.

The cylinder may include a cylinder body in which the piston is reciprocally movably received, and an end of the cylinder body coming into contact with the brake shoe may be provided with a fitting recess, into which the end of the brake shoe is fitted.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a sectional view illustrating the configuration of a wheel cylinder usable with a conventional drum brake;

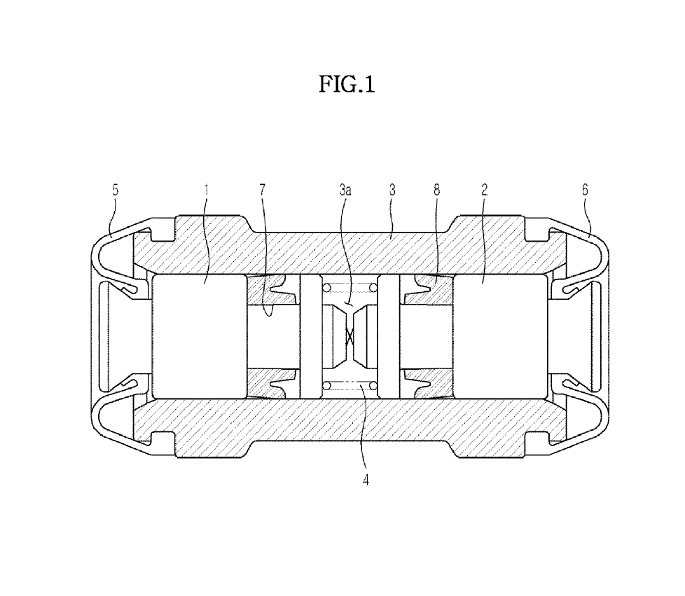

FIG. 2 is a front view illustrating the configuration of a drum brake according to an exemplary embodiment of the present invention;

FIG. 3 is a sectional view illustrating a braking-released state of a wheel cylinder in the drum brake according to the exemplary embodiment of the present invention;

FIG. 4 is a sectional view illustrating a braked state of the wheel cylinder in the drum brake according to the exemplary embodiment of the present invention; and

FIG. 5 is a sectional view illustrating a braking-released state of a wheel cylinder in a drum brake according to another exemplary embodiment of the present invention.

### DETAILED DESCRIPTION

Reference will now be made in detail to the configuration of a drum brake according to the exemplary embodiment of the present invention, examples of which are illustrated in the accompanying drawings, wherein like reference numerals refer to like elements throughout.

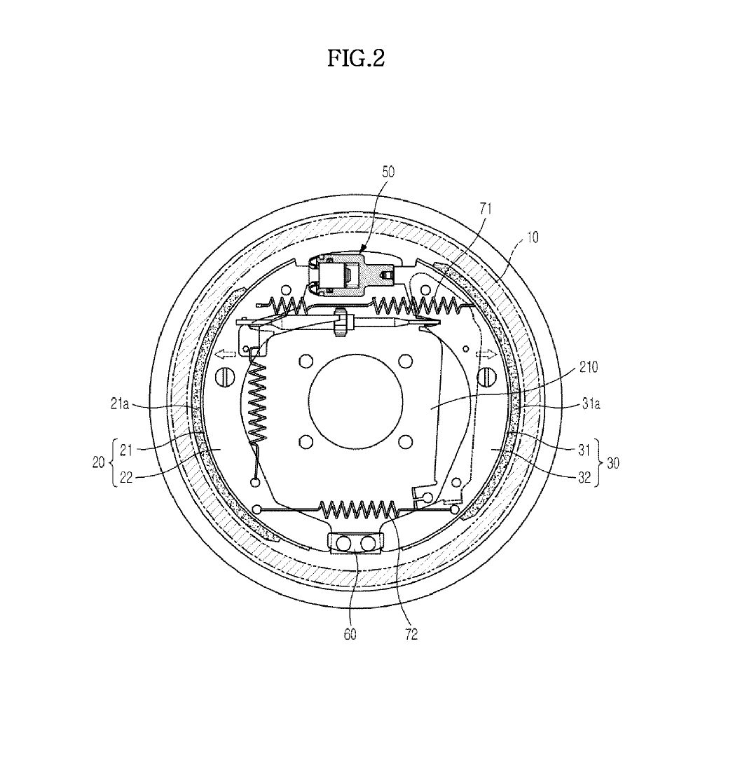

As shown in FIG. 2, the drum brake according to the present embodiment includes a pair of brake shoes 20 and 30 placed within a drum 10 that rotates along with a vehicle wheel.

The pair of brake shoes 20 and 30 is mounted to a backing plate 40 in an outwardly operable manner. The backing plate 40 is secured to a knuckle of a vehicle so as to be opposite the drum 10.

The brake shoes 20 and 30 respectively include semicircular rims 21 and 31 having linings 21a and 31a attached to outer surfaces thereof to generate brake force via friction with an inner surface of the drum 10, and support webs 22 and 32 provided at inner surfaces of the rims 21 and 31 to increase the strength of the rims 21 and 31.

The pair of brake shoes 20 and 30 may include a first brake shoe 20 for frictional interaction with one side of the inner surface of the drum 10, and a second brake shoe 30 for frictional interaction with an opposite side of the inner surface of the drum 10.

A wheel cylinder 50 is installed between one end of each of the first and second brake shoes 20 and 30. The wheel cylinder 50 forces the webs 22 and 32 of the brake shoes 20 and 30 to push the brake shoes 20 and 30 outward against the inner surface of the drum 10. The wheel cylinder 50 may push the first and second brake shoes 20 and 30 in the outward operating direction upon receiving braking hydraulic pressure created in a master cylinder. In FIG. 2, the arrows indicate the outward operating direction of the respective brake shoes 20 and 30.

The other ends of the pair of brake shoes 20 and 30 are rotatably supported by an anchor block 60 interposed therebetween. Also, return springs 71 and 72 are connected between the first and second brake shoes 20 and 30 to assist the brake shoes 20 and 30 in restoring an original state thereof once the braking hydraulic pressure applied to the wheel cylinder 50 is removed.

The anchor block 60 is mounted to the backing plate 40 at a position between both ends of the first and second brake shoes 20 and 30.

In the drum brake having the above-described configuration, if a driver steps on a brake pedal, braking hydraulic pressure created by the master cylinder is transmitted to the wheel cylinder 50, causing the wheel cylinder 50 to push the first and second brake shoes 20 and 30 outward in opposite directions about the anchor block 60. Thereby, a vehicle wheel is braked via friction generated between the linings 21a and 31a of the brake shoes 20 and 30 and the inner surface of the drum 10.

If the driver takes their foot off the brake pedal in such a braked state to remove the braking hydraulic pressure applied to the wheel cylinder 50, the first and second brake shoes 20 and 30 pushed outward against the inner surface of the drum 10 restore an original state thereof by elasticity of the return springs 71 and 72, releasing the vehicle wheel from the braked state.

Meanwhile, in the drum brake according to the present embodiment, the wheel cylinder 50 is configured to push both the brake shoes 20 and 30 outward using only a single piston 80 and a single cylinder 90, thus having a reduced size and manufacturing cost.

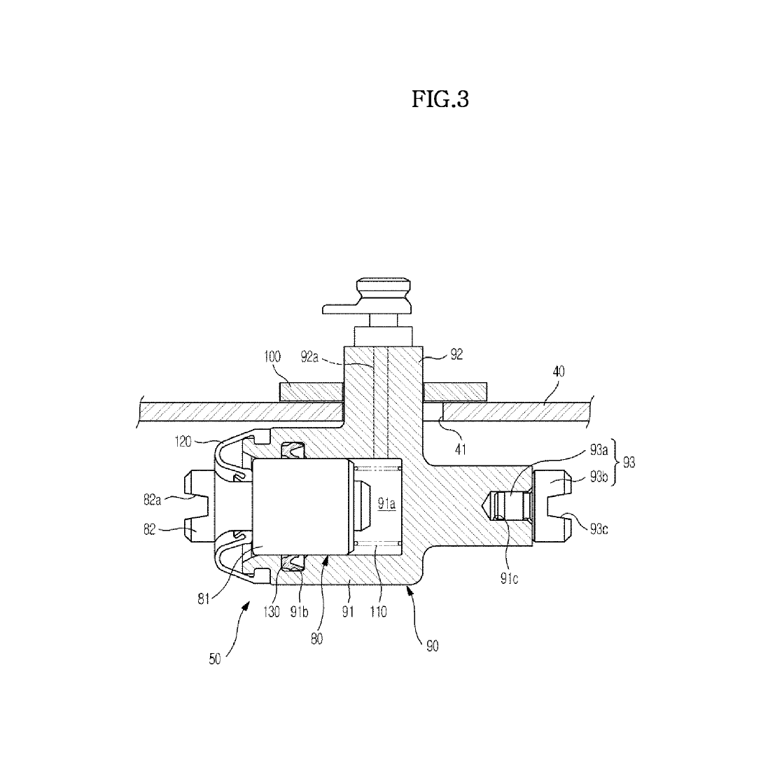

Considering this configuration of the wheel cylinder 50 in more detail with reference to FIG. 3, the wheel cylinder 50 includes the piston 80 to push the first brake shoe 20 outward, and the cylinder 90 in which the piston 80 is reciprocally movably received, the cylinder 90 being installed to one end of the second brake shoe 30 to slide in an outward operating direction so as to push the second brake shoe 30 outward in linkage with operation of the piston 80.

The cylinder 90 includes a cylinder body 91 defining a cylinder chamber 91a, one side of which is open such that the piston 80 is reciprocally movably received therein, and a coupling portion 92 integrally extending rearward from the cylinder body 90 for coupling with the backing plate 40. The backing plate 40 located at the rear of the cylinder 90 has a sliding hole 41 perforated therein such that the coupling portion 92 is slidably fitted into the sliding hole 41. The coupling portion 92 has a hydraulic pressure path 92a to guide hydraulic pressure transmitted from the master cylinder to the cylinder chamber 91a. A fixing member 100 is coupled to the coupling portion 92 behind the backing plate 40 to prevent the coupling portion 92 slidably fitted into the sliding hole 41 from being separated from the sliding hole 41.

The piston 80 includes a body 81 having an outer wall slidably supported by an inner wall of the cylinder chamber 91 a, and a contact portion 82 integrally formed at a leading end of the body 81 to come into contact with the web 22 of the first brake shoe 20. The contact portion 82 has a fitting recess 82a such that the web 22 of the first brake shoe 20 is fitted into the fitting recess 82a. Reference numeral 110 denotes a spring installed in the cylinder chamber 91a inside the piston 80 to elastically support the body 81 of the piston 80.

To prevent the hydraulic pressure applied into the cylinder chamber 91a through the hydraulic pressure path 92a from leaking out of the cylinder 90 and to prevent foreign substances at the outside of the cylinder 90 from entering the cylinder chamber 91a, a boot 120 is interposed between the open end of the cylinder 20 and the periphery of the contact portion 82 of the piston 80. Also, a seal 130 is seated in an insertion recess 91 b indented in the inner wall of the cylinder chamber 91a to reduce loss of hydraulic pressure applied to the piston 80.

The cylinder 90 further includes a contact member 93 secured to one side of the cylinder body 91 so as to come into contact with the second brake shoe 30. The contact member 93 includes a fixing portion 93a disposed toward the cylinder body 91 and a contact portion 93b disposed toward the second brake shoe 30. The fixing portion 93a is inserted into a coupling recess 91c indented in the cylinder body 91 such that the contact member 93 is integrated with the cylinder body 91. The contact portion 93b has a fitting recess 93c into which the web 32 of the second brake shoe 30 is fitted, and comes into direct contact with the second brake shoe 30.

In the present embodiment, the contact member 93, which is separate from the cylinder body 91, is provided at the portion of the cylinder 90 coming into contact with the second brake shoe 30. Thus, it may be possible to form the contact member 93, which is kept in direct contact with the second brake shoe 30 upon braking, using a material having a greater strength than the cylinder body 91, which may prevent the cylinder 90 from being worn due to contact with the second brake shoe 30. The contact member 93 may be formed of the same material as the piston 80.

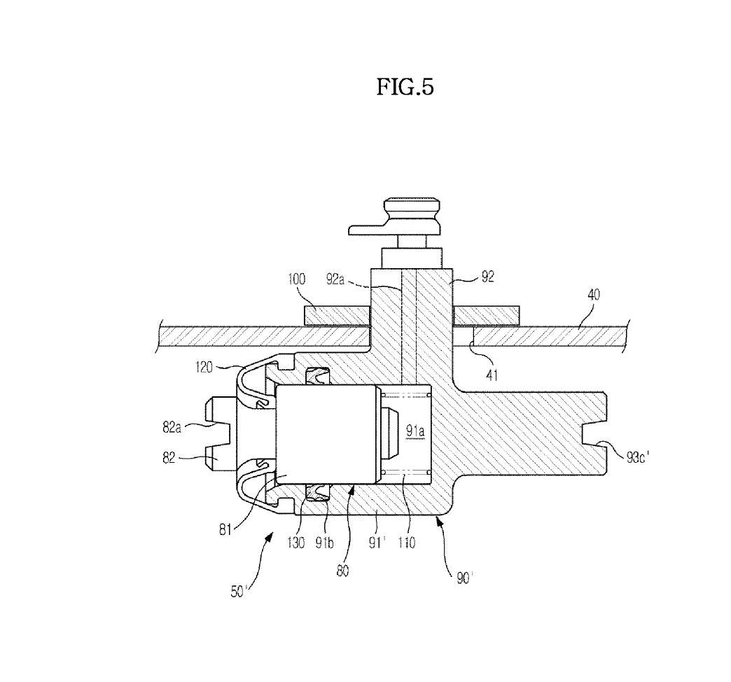

Of course, as shown in FIG. 5 illustrating the configuration of a wheel cylinder 50′ according to another embodiment of the present invention, a cylinder body 91′ of a cylinder 90′ may be shaped such that the web 32 is directly fitted thereinto without requiring the separately prepared contact member 93. Specifically, as shown in FIG. 5, when providing an end of the cylinder body 91′ supported by the second brake shoe 30 with a fitting recess 93c′ into which the web 32 of the second brake shoe 30 is fitted, the cylinder 90′ may efficiently act to push the second brake shoe 30 outward upon operation of a wheel cylinder 50′ despite omission of the contact member 93. In the present embodiment, other configurations except for the shape of the end of the cylinder body 91′ replacing the contact member 93 are identical to the above firstly described embodiment, and thus a detailed description thereof will be omitted hereinafter.

Meanwhile, differently from the above description in which the coupling portion 92 of the cylinder 90; 90′ is slidably fitted into the sliding hole 41 of the backing plate 40 to ensure more stable sliding of the cylinder 90; 90′ during outward operation of the brake shoes 20 and 30, the wheel cylinder 50; 50′ may be elastically supported between the brake shoes 20 and 30 even in a state in which the end of the piston 80 is simply supported by the first brake shoe 20 and the end of the cylinder 90; 90′ is simply supported by the second brake shoe 30. Accordingly, both the brake shoes 20 and 30 may be smoothly operated outward via sliding of the cylinder 90; 90′ despite omission of the coupling portion 92 and the sliding hole 41.

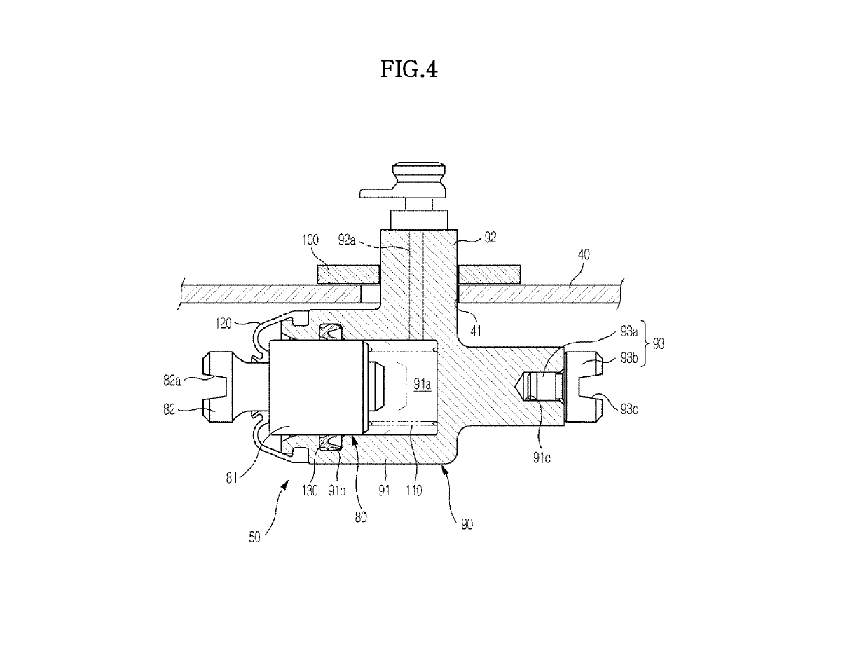

FIG. 4 illustrates an operational state of the wheel cylinder 50. As shown in FIG. 4, if braking hydraulic pressure is applied to the cylinder chamber 91 a in a state as shown in FIG. 3, the piston 80 is moved to push the first brake shoe 20 outward by the braking hydraulic pressure applied to the cylinder chamber 91a. In linkage with this operation of the piston 80, the cylinder 90 stably slides within the sliding hole 41 to push the second brake shoe 30 outward. Accordingly, the first and second brake shoes 20 and 30 are almost simultaneously pushed outward, causing the wheel to be braked. Then, if the braking hydraulic pressure applied to the cylinder chamber 91a is removed, the first and second brake shoes 20 and 30 are returned by elasticity of the return springs 71 and 72, causing the piston 80 to be moved backward into the cylinder chamber 91a and the cylinder 90 to slide to an original position thereof within the sliding hole 41.

As is apparent from the above description, the drum brake according to the embodiment may achieve efficient braking of a vehicle with the simplified configuration in which the wheel cylinder 50 includes the single piston 80 and the single cylinder 90.

Accordingly, according to the present embodiment, the number of elements, such as boots, seals, etc., accompanied with the piston as well as the number of pistons may be reduced, which effectively reduces manufacturing cost of the wheel cylinder 50.

The wheel cylinder 50 having the single piston 80 has a shorter total length than a conventional wheel cylinder having a pair of pistons, and thus may be advantageous in view of volume.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A drum brake comprising a backing plate installed opposite a drum that rotates along with a wheel, a pair of brake shoes installed in both sides of the drum to generate brake force via friction with an inner surface of the drum when pushed outward, and a wheel cylinder located between one end of each of the pair of brake shoes to push the pair of brake shoes outward,
wherein the wheel cylinder includes a piston to push one end of any one of the pair of brake shoes outward, and a cylinder in which the piston is reciprocally movably received, the cylinder being installed to slide in linkage with operation of the piston so as to push one end of the other one of the pair of brake shoes outward,
wherein the cylinder has a coupling portion for coupling with the backing plate, and
wherein the backing plate has a sliding hole such that the coupling portion is slidably fitted into the sliding hole.

2. The drum brake according to claim 1, wherein the cylinder includes a cylinder body in which the piston is reciprocally movably received, and a contact member secured to one side of the cylinder body so as to come into contact with the brake shoe.

3. The drum brake according to claim 2, wherein an end of the contact member coming into contact with the brake shoe is provided with a fitting recess, into which the end of the brake shoe is fitted.

4. The drum brake according to claim 1, wherein the cylinder includes a cylinder body in which the piston is reciprocally movably received, and an end of the cylinder body coming into contact with the brake shoe is provided with a fitting recess, into which the end of the brake shoe is fitted.

5. A wheel cylinder installed in a drum brake to push a pair of brake shoes placed in both sides of the drum outward, the wheel cylinder comprising:
a piston to push any one of the pair of brake shoes outward; and
a cylinder in which the piston is reciprocally movably received, the cylinder being installed to slide in linkage with operation of the piston so as to push the other one of the pair of brake shoes outward,
wherein the cylinder is slidably fitted into a sliding hole formed in a backing plate of the drum brake.

6. The wheel cylinder according to claim 5, wherein the cylinder includes a cylinder body in which the piston is reciprocally movably received, and a contact member secured to one side of the cylinder body so as to come into contact with the brake shoe.

7. The wheel cylinder according to claim 6, wherein an end of the contact member coming into contact with the brake shoe is provided with a fitting recess, into which an end of the brake shoe is fitted.

8. The wheel cylinder according to claim 5, wherein the cylinder includes a cylinder body in which the piston is reciprocally movably received, and an end of the cylinder body coming into contact with the brake shoe is provided with a fitting recess, into which an end of the brake shoe is fitted.
